(19) United States
(12) Patent Application Publication
(10) Pub. No.: US 2022/0391684 A1
(43) Pub. Date: Dec. 8, 2022

(54) ASYNCHRONOUS MIXED PRECISION UPDATE OF RESISTIVE PROCESSING UNIT ARRAY

(71) Applicant: International Business Machines Corporation, Armonk, NY (US)

(72) Inventor: Malte Johannes Rasch, Chappaqua, NY (US)

(21) Appl. No.: 17/336,392

(22) Filed: Jun. 2, 2021

(51) Int. Cl. G06N 3/08; G06N 3/063; G06F 15/80

(52) U.S. Cl. CPC G06N 3/08; G06N 3/0635; G06F 15/80

(57) ABSTRACT

A computer-implemented method, computer program product, and/or computer system that performs the following operations: (i) receiving outputs pertaining to a first step of a training process being performed on an analog resistive processing unit (RPU) array, the analog RPU array corresponding to a layer of a deep neural network (DNN); (ii) converting the outputs into a format having less precision, yielding converted outputs; (iii) initiating a calculation of an update parameter for a first step update pass of the layer utilizing the converted outputs; and (v) based, at least in part, on receiving outputs pertaining to a second step of the training process being performed on the analog RPU array, applying the update parameter for the first step update pass of the layer to the analog RPU array.

### BACKGROUND

The present invention relates generally to the field of neuromorphic computing, and more particularly to the training of neuromorphic computing devices that include analog arrays of resistive processing unit (RPU) devices.

Neuromorphic computing generally involves the use of computer technology to mimic neuro-biological architectures present in the nervous system. As an example, an artificial neural network (ANN) is a type of neuromorphic computing system having nodes that generally mimic neurons and connections between the nodes that generally mimic synapses, with the connections between the nodes having respective synaptic weights.

A deep neural network (DNN) is an ANN with multiple layers between input and output layers. One way of implementing a DNN is by utilizing one or more analog crossbar arrays of memory devices such as resistive processing units (RPUs). In some implementations, analog RPU arrays are combined with digital processing units and additional memory in what is generally referred to as a “mixed-precision” architecture.

### SUMMARY

According to an aspect of the present invention, there is a computer-implemented method, computer program product, and/or computer system that performs the following operations (not necessarily in the following order): (i) receiving outputs pertaining to a first step of a training process being performed on an analog resistive processing unit (RPU) array, the analog RPU array corresponding to a layer of a deep neural network (DNN), the outputs including: (i) a first output of a first step forward pass of a previous layer, and (ii) a second output of a first step backward pass of a next layer; (ii) converting the first output and the second output into a format having less precision than a format of the first output and a format of the second output, yielding a converted first output and a converted second output; (iii) initiating a calculation of an update parameter for a first step update pass of the layer, the calculation utilizing the converted first output and the converted second output; (iv) receiving outputs pertaining to a second step of the training process being performed on the analog RPU array; and (v) based, at least in part, on the receiving of the outputs pertaining to the second step of the training process being performed on the analog RPU array, applying the update parameter for the first step update pass of the layer to the analog RPU array.

### BRIEF DESCRIPTION OF THE DRAWINGS

FIG. 1 is a block diagram view of a first embodiment of a system, according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a flowchart showing another method, according to an embodiment of the present invention;

FIG. 5 is a diagram depicting an analog RPU array system, in a forward pass, according to an embodiment of the present invention;

FIG. 6 is a diagram depicting a transposed analog RPU array system, in a backward pass, according to an embodiment of the present invention;

FIG. 7 is a diagram depicting a digital and analog RPU array system, in an update pass, according to an embodiment of the present invention; and

FIG. 8 is a diagram depicting an example runtime scheme, according to an embodiment of the present invention.

### DETAILED DESCRIPTION

Mixed-precision dynamic neural network (DNN) architectures allow for some aspects of the DNN training process to be performed on analog resistive processing unit (RPU) arrays and other aspects to be performed on digital processing units (e.g., “traditional” computer processors). For example, in a three-step training process that includes a forward pass, a backward pass, and an update pass, the forward pass and the backward pass can be performed on an analog RPU array while calculations associated with the update pass can be performed on digital, avoiding various issues that can occur when performing these calculations on analog devices. But such an approach also includes a number of drawbacks, as the runtime cost and storage cost associated with performing the calculations in high precision digital can be quite high. And while some have proposed performing update calculations in low precision, those proposals have also had associated performance costs, particularly relating to the amount of time it takes for the calculations to complete. Embodiments of the present invention perform update calculations not only in low precision digital, but also asynchronously with respect to the other update calculations being performed, thereby reducing performance issues associated with high precision calculations and/or calculations requiring synchronous performance. In this way, as will be discussed in further detail below, embodiments of the present invention improve upon existing configurations by significantly reducing memory and runtime requirements for mixed-precision update.

This Detailed Description section is divided into the following sub-sections: (i) The Hardware and Software Environment; (ii) Example Embodiment; (iii) Further Comments and/or Embodiments; and (iv) Definitions.

### I. THE HARDWARE AND SOFTWARE ENVIRONMENT

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

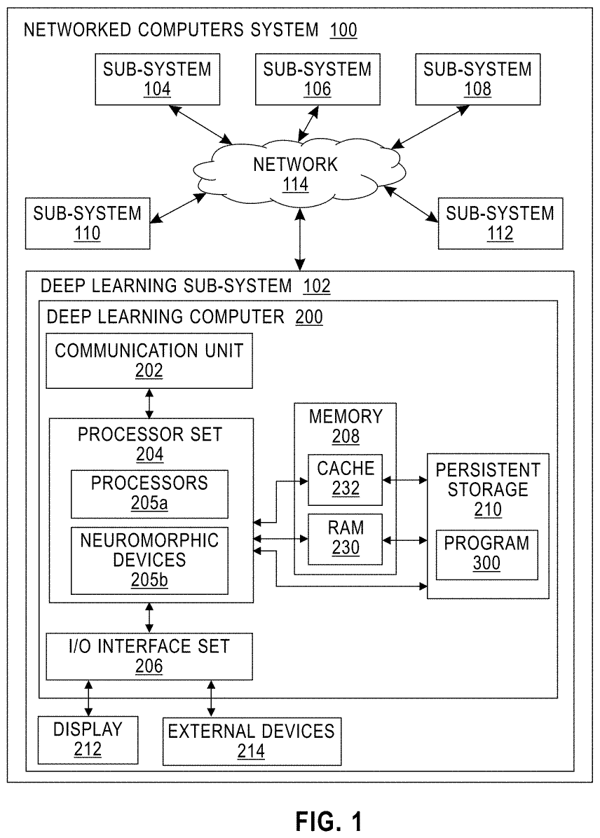

An embodiment of a possible hardware and software environment for software and/or methods according to the present invention will now be described in detail with reference to the Figures. FIG. 1 is a functional block diagram illustrating various portions of networked computers system 100, including: deep learning sub-system 102; deep learning sub-systems 104, 106, 108, 110, 112; communication network 114; deep learning computer 200; communication unit 202; processor set 204, including computer processors 205a and neuromorphic devices 205b; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more processors of processor set 204, including respective subsets of computer processors 205a and/or neuromorphic devices 205b, usually through one or more memories of memory 208. In some embodiments, some or all of program 300 may be included on and/or operated by computer processors 205a, in some embodiments some or all of program 300 may be included on and/or operated by neuromorphic devices 205b, and in some embodiments a combination of computer processors 205a and neuromorphic devices 205b may be used.

While computer processors 205a generally include mostly “conventional” computer processors, neuromorphic devices 205b include analog neuromorphic devices such as RPU crossbar arrays. Generally speaking, RPU crossbar arrays are high density, low cost circuit architectures used to model DNNs. The crossbar array configuration includes a set of conductive row wires and a set of conductive column wires formed to intersect the set of conductive row wires. The intersections between the row wires and the column wires are separated by crosspoint devices—in this case, RPUs— which may be formed from thin film material. These crosspoint devices function as the weighted connections between neurons in a DNN. The RPUs themselves include resistive memory devices such as resistive random-access memory (ReRAM) devices, phase-change memory (PCM) devices, and the like, which have a tunable conductance which represents the synaptic weights and can be used to perform various DNN-related calculations. In various embodiments, each RPU crossbar array of neuromorphic devices 205b corresponds to a different respective layer of a DNN, such that the DNN as a whole is represented by a set of RPU crossbar arrays (one for each layer). In other embodiments, a single layer of a DNN may span multiple RPU crossbar arrays, or alternatively, multiple layers of a DNN may be represented by a single RPU crossbar array.

Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with deep learning computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. EXAMPLE EMBODIMENT

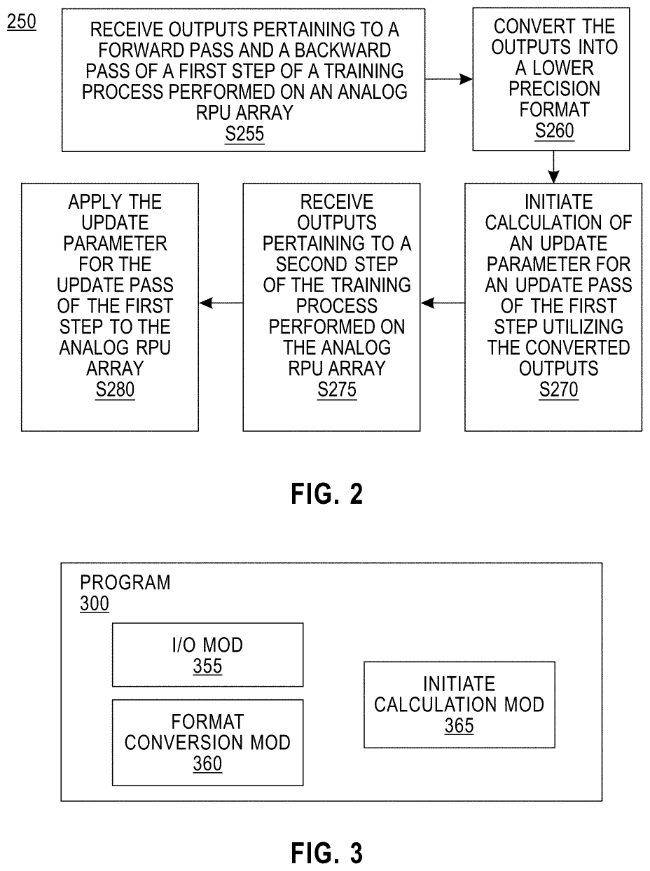

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Generally speaking, in this example embodiment (also referred to in this sub-section as the “present embodiment,” the “present example,” the “present example embodiment,” and the like), program 300 includes various operations performed by computer processors 205a (see FIG. 1) for the purpose of training a DNN stored on a set of analog RPU arrays (not shown) of neuromorphic devices 205b (see FIG. 1). It should be noted that this example embodiment is used herein for example purposes, in order to help depict the scope of the present invention. As such, other embodiments (such as embodiments discussed in the Further Comments and/or Embodiments sub-section, below) may be configured in different ways or refer to other features, advantages, and/or characteristics not fully discussed in this sub-section.

The DNN of the present example embodiment is implemented on a set of analog RPU arrays, one for each layer of the DNN, of neuromorphic devices 205b. In other embodiments, each layer of the DNN may correspond to multiple analog RPU arrays, or multiple layers of the DNN may correspond to a single analog RPU array—for example, all of the layers of the DNN may be implemented on a single analog RPU array. And while FIG. 1 depicts neuromorphic devices 205b as being located within processor set 204 of deep learning computer 200 on deep learning sub-system 102, in other embodiments the various analog RPU arrays used to implement the DNN are distributed across several such sub-systems—for example, on sub-systems 104, 106, 108, 110, and/or 112. The distributed nature of providing analog RPU arrays across several such computing sub-systems may provide several performance and/or configuration benefits, as will be discussed in further detail below.

Each analog RPU array of the set of analog RPU arrays includes several rows and columns of weighted nodes (i.e., RPU devices). The training of the DNN uses stochastic gradient descent (SGD), in which the weight (sometimes also referred to as an “error gradient”) of each node is calculated using backpropagation. Backpropagation generally includes sequentially processing each layer of the DNN through multiple steps of a three-part training process that includes a forward pass, a backward pass, and a weight update pass (or simply an “update pass”), with each pass having respective calculations that are performed. The three-part process is typically repeated until a convergence criterion is met.

In the present example embodiment, the forward pass and the backward pass for each layer, along with the associated calculations, are performed directly on an analog RPU array itself; the focus of the following discussion will instead be on the update pass, which will be implemented on an analog RPU array but which will have various calculations performed digitally using computer processors 205a of processor set 204. As will be discussed in further detail below, performing these calculations on digital, particularly low precision digital, in the manner described provides significant performance benefits over conventional methods for performing update pass calculations.

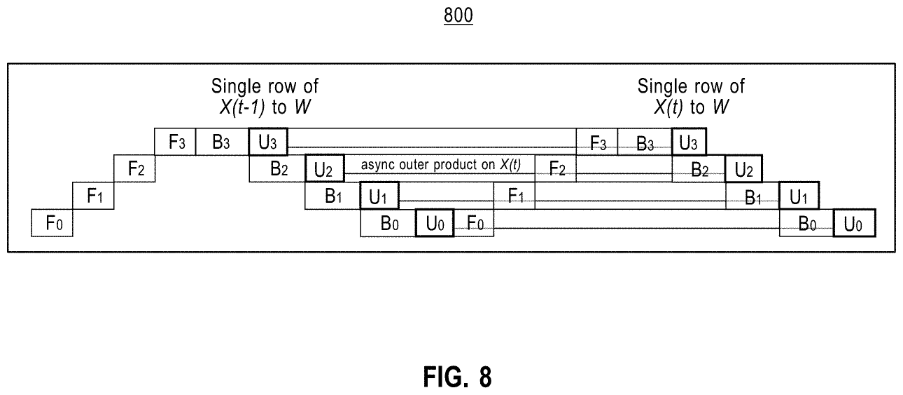

Processing begins at operation S255, where input/output (I/O) module (“mod”) 355 receives outputs pertaining to a forward pass and a backward pass of a first step of a training process performed on an analog RPU array. In this embodiment, the analog RPU array (also referred to as the “current analog RPU array”) corresponds to a layer (also referred to as the “current layer”) of the DNN, and the outputs pertaining to the forward pass and the backward pass include at least: (i) a first output of a first step forward pass of a previous layer (i.e., a layer preceding the current layer), provided as a digital vector of real numbers, and (ii) a second output of a first step backward pass of a next layer (i.e., a layer succeeding the current layer), also provided as a digital vector of real numbers. In this embodiment, because the forward pass passes through the layers of the DNN in order, and because the backward pass passes through the layers of the DNN in reverse order, the first output of the first step forward pass of the previous layer is a first input to a first step forward pass of the current layer, and the second output of the first step backward pass of the next layer is a second input to a first step backward pass of the current layer. An example runtime scheme depicting the sequential processing of layers of a DNN through a forward pass and a backward pass of a training process can be found in FIG. 8, discussed below in the Further Comments and/or Embodiments sub-section of this Detailed Description.

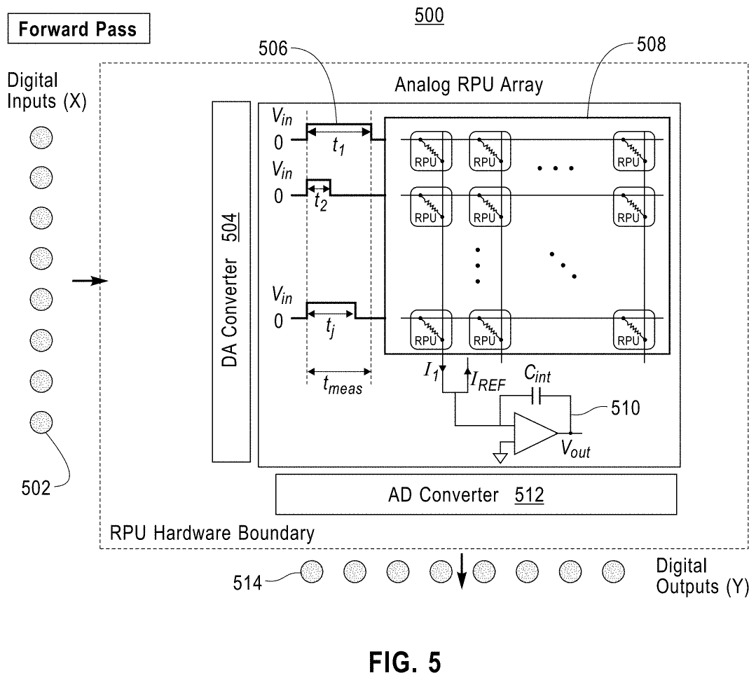

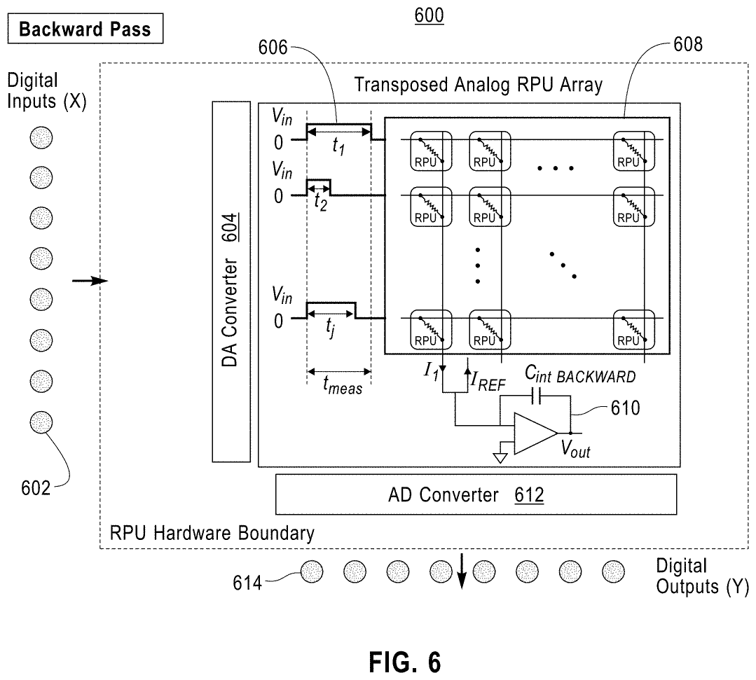

In various embodiments, the first output and the second output are produced by their respective analog RPU arrays by converting analog computation results to digital via an analog to digital (AD) converter, such as AD converters 512 and 612 of FIGS. 5 and 6, respectively, also discussed below in the Further Comments and/or Embodiments sub-section of this Detailed Description. Various analog to digital conversion schemes may be utilized, such as those now known and/or those yet to be developed in the future.

Processing proceeds to operation S260, where format conversion mod 360 converts the first output and the second output into a lower precision format—that is, into a format having less precision than a format of the first output and a format of the second output—yielding a converted first output and a converted second output. A motivation for performing this conversion, at least in the present example embodiment, is to reduce the runtime cost of various update pass-related operations to be performed by computer processors 205a, as well as to reduce the storage requirements for data relating to those operations.

In the present example embodiment, the conversion involves converting the first output and the second output from vectors of real numbers to vectors of integers—particularly, 8-bit integers. It should be noted, however, this is only one example of a conversion to lower precision. In other embodiments, other formats and conversion schemes may be utilized, including those now known and/or those yet to be developed in the future, with the primary requirement being that the converted first output and the converted second output are in lower precision than the received first output and the received second output. Some other examples include: (i) receiving the outputs in a high precision floating-point format, such as double-precision floating-point format (64 bits), and converting to a lower precision floating-point format, such as single-precision floating-point format (32 bits) or half-precision floating-point format (16 bits); (ii) receiving the outputs in a floating-point format, such as single-precision floating-point format (32 bits), and converting to a lower precision integer format, such as 8-bit integers; and/or (iii) receiving the outputs in a higher precision integer format, such as 16-bit integers, and converting to a lower precision integer format, such a 8-bit or even 4-bit integers. Additionally, while the above examples depict the first output and the second output having the same respective amounts of precision, in some embodiments the first output may have a different level of precision than the second output, and the conversion process may convert the first output and the second output to the same or different respective lower precision formats.

Processing proceeds to operation S270, where initiate calculation mod 365 initiates calculation of an update parameter for an update pass of the first step utilizing the converted outputs. In various embodiments, including the present example embodiment, the update parameter is an outer product that includes a vector-vector multiplication of the converted first output and the converted second output, although in other embodiments other types of update parameters may be calculated, including those now known and those to be developed in the future.

In the present example embodiment, and in various other embodiments of the present invention, the update parameter is calculated using a dedicated set of computer processors (also referred to as a “set of digital processing units”) designed to mimic the structure of the analog RPU array. In these embodiments, the dedicated set of computer processors—located in computer processors 205a, for example—includes a dedicated computer processor for each analog tile (i.e., RPU) of the analog RPU array. The initiation of the calculation of the update parameter then involves sending an instruction to this dedicated set of computer processors to begin calculating the update parameter.

A helpful feature of the present example embodiment is that it performs the calculation of the update parameter asynchronously with respect to calculations being performed for other layers of the DNN. In other words, program 300 does not wait for the update parameter calculation to complete before continuing processing. Instead, program 300 utilizes the update parameter from the previous step of the training process for the current layer to immediately provide an update to the analog RPU array. While the present discussion will continue with the following step—the second step of the training process—the iterative nature of the operations of flowchart 250 means that for any given step of the training process, the results of the previous step's update parameter calculation for a layer will be utilized for that step. For the first step of the training process, which has no “previous” step, a default value, such as zero, may be utilized.

Processing proceeds to operation S275, where I/O mod 355 receives outputs pertaining to the second step of the training process performed on the analog RPU array. Functionally, the processing of operation S275 is mostly the same as the processing of operation S255, with a primary difference being that in operation S275, the outputs pertain to the second step of the training process instead of the first step. It should also be understood that due to the sequential nature of DNN training via backpropagation—where the forward pass processes layers of the DNN sequentially beginning with a beginning layer, and where the backward pass processes layers of the DNN in reverse sequence beginning with a final layer—processing related to other layers of the DNN likely has occurred between the receiving of the outputs pertaining to the first step and the receiving of the outputs pertaining to the second step for the analog RPU array. For example, in many cases, subsequent to receiving the outputs pertaining to the first step of the training process performed on the analog RPU array, and prior to receiving the outputs pertaining to the second step of the training process performed on the analog RPU array, program 300 (or similar programs operating on other sub-systems of networked computers system 100) will have received outputs pertaining to the first step of the training process performed on a next analog RPU array corresponding to a next layer of the DNN (i.e., the next layer after the current layer), and will also have received outputs pertaining to the second step of the training process performed on the next analog RPU array. Although the discussion of the present example embodiment is mostly focused on processing related to the current analog RPU array through the multiple steps of its training, the iterative nature of the operations of flowchart 250 means that similar processing will typically also occur for the other analog RPU arrays corresponding to the other respective layers of the DNN, and in the order/sequence required for the training process being implemented. Again, some example illustrations of runtime schemes that demonstrate such an order/sequence can be found in FIG. 8, discussed below in the Further Comments and/or Embodiments sub-section of this Detailed Description.

Processing proceeds to operation S280, where I/O mod 355 applies the update parameter for the update pass of the first step of the training process to the analog RPU array—based, at least in part, on the receiving of the outputs pertaining to the second step in operation S275. Here, as suggested above, program 300 uses the update parameter for the first step as the update parameter for the second step, allowing processing to continue in a synchronous manner while beginning the calculation of the update parameter for the second step (not shown).

Because the update parameter for the first step is calculated asynchronously with respect to various other operations, in some cases, operation S280 must wait for the update parameter calculation to complete before applying the update parameter to the analog RPU array. In various embodiments, configuration parameters and resource allocations may be modified to optimize the timing of the completion of the update parameter calculation—for example, to ensure that the update parameter calculation for the first step completes as close to the receipt of the outputs of the second step as possible, or within a threshold amount of time. For example, in some embodiments, the amount of the precision reduction in operation S260 is adjusted to provide for the desired completion timing.

In various embodiments, the update parameter is a digital integer value which indicates a number of deterministic pulses to be added to an analog value for the update pass at the analog RPU array. Specific details regarding how analog RPU arrays apply update parameters to their various RPUs— using deterministic pulses, for example—are discussed in further detail below, in the Further Comments and/or Embodiments sub-section of this Detailed Description.

In various embodiments, including the present example embodiment, applying the update parameter for the update pass of the first step includes combining the calculated update parameter (e.g., the result of a vector-vector multiplication) with a learning rate and various bin-widths associated with the second step—details of which are also provided below, in the Further Comments and/or embodiments sub-section of this Detailed Description. As such, program 300 is able to incorporate the learning rate and bin-widths from the most recently performed step to the asynchronously calculated update parameter of the first step, resulting in a more accurate update pass than if an “older” learning rate and/or bin-width had been used.

### III. FURTHER COMMENTS AND/OR EMBODIMENTS

Various embodiments of the present invention provide a computer system with one or more RPU crossbar arrays that are enhanced with dedicated reduced precision digital processing units for specialized update computations.

Various embodiments of the present invention use a reduced precision training method for an artificial neural network (ANN) system with analog RPU crossbar arrays that are enhanced with dedicated digital reduced precision units.

Various embodiments of the present invention perform asynchronous integer digital update and sparse transfer to analog RPU crossbar arrays for ANN training.

In various embodiments, memory and run time requirements for mixed precision updates are significantly improved due to reduced precision and asynchronous compute.

Various embodiments of the present invention recognize several areas of improvement with respect to the current state of the art—specifically, in the training of DNNs using analog resistive crossbar arrays as in-memory compute for forward, backward, and update steps of the training.

As an example, in certain existing methods, instead of doing an outer product update step directly on analog, the rank update (which is necessary for DNN training) is computed on digital and then transferred to analog devices by sparse row-wise update. While this circumvents non-linearities and noise of analog devices that could accumulate during repeated updates, it comes, at least in existing methods, with significant runtime penalties (e.g., slow digital compute in high precision).

For example, an update cycle may include the following steps, where W is the analog matrix, X is the matrix in high floating point precision, x is the input used in forward propagation, and d is the error used in backward propagation: (i) ΔW=xd^{T} is computed in high-precision digital (floating point); (ii) Xₜ=Xₜ₋₁+ΔW is computed in high-precision digital; and (iii) └Xₜ/∈┘ is used to update the analog W, where E is the device step granularity (i.e., the minimal update step Δwₘᵢₙ), and where a full matrix update is provided for each sample, iterating through all columns/rows, but possibly omitting some zero rows/columns.

Some existing methods also apply quantization to the steps described in the previous paragraph, resulting in the following modified steps: (i) quantize x to integers x_{q} in a constant range with linear quantization (pre-established for each layer); (ii) quantize d in a dynamic, symmetric way to integers (e.g., round d/∝ with ∝=max(|dᵢ|)) computed layer-wise for each mini-batch; (iii) compute ΔW_{q}=x_{q} d_{q}^{T} in low-precision integer; (iv) re-scale by computing ΔW=ηΔW_{q} ∝ (in high bit precision); (v) compute Xₜ=Xₜ₋₁+ΔW in high bit-precision; and (vi) use └Xₜ/∈┘ to update the analog W, where E is the device step granularity (i.e., the minimal update step Δwₘᵢₙ).

Various embodiments of the present invention recognize that existing mixed precision methods such as those described above have a number of drawbacks, including runtime cost of ϑ(n²) operations (addition and scaling) in high-precision and storage requirements of the high-precision X and ΔW. Various embodiments further recognize the following facts, potential problems, and/or potential areas for improvement with respect to existing mixed precision methods: (i) storage requirement: X needs to be available in high precision; (ii) on-chip memory requirement: full high-precision matrices ΔW and X need to fit into on-chip memory for gradient additions and gradient scaling; (iii) ϑ(nonzero(d_{q})nonzero(x_{q})) gradient scaling and high-precision addition operations need to be performed for each sample; (iv) slow update: each cycle (potential), the full matrix W is updated, one update per row (although all-zero rows can be omitted, doing so would incur variable runtime cost that is undesirable for pipelining); and (v) synchronous (and slow digital) update is at odds with fast analog forward and backward for pipelined situations.

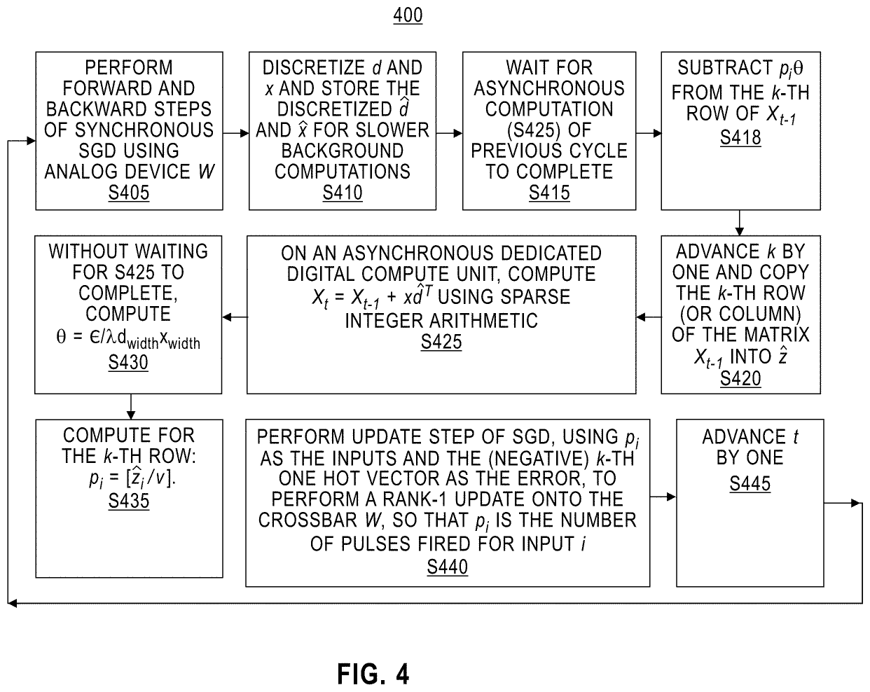

FIG. 4 shows flowchart 400 depicting a method, according to an embodiment of the present invention. In this embodiment, the method utilizes integer multiplications and additions to perform an asynchronous mixed precision update of an RPU crossbar array, where operations S405, S410, S415, S418, S420, S425, S430, S435, S440, and S445 are performed for each update cycle of the training process. In this embodiment, each update cycle corresponds to a “mini-batch” of the overall training data, such that processing completes when all mini-batches have been processed.

Processing begins with operation S405, where the training process performs the forward and backward steps of synchronous stochastic gradient descent (SGD) using analog device W, through the network (e.g., using gPipe), until the update step of the current layer would be needed (i.e., after finishing the backward computation, where d^{prev layer}=W^{T} d). As an example, the forward step of SGD (also referred to as a “forward pass”) may be performed by analog RPU array system 500, described below with respect to FIG. 5. As another example, the backward step of SGD (also referred to as a “backward pass”) may be performed by transposed analog RPU array system 600, described below with respect to FIG. 6.

Processing proceeds to operation S410, where the training process discretizes d (the output of the backward pass) and x (the output of the forward pass) and stores the discretized vectors \hat{d} and \hat{x} for slower background computations. More particularly, in this operation, the training process: (i) computes xₘₓ=maxᵢ|xᵢ| for noise management and updates μₓ^{(t)}=γμₓ^{(t-1)}+(1−γ)xₘₓ; (ii) computes dₘₓ=maxⱼ|dⱼ| for noise management and updates μ_{dx}^{(t)}=γμ_{d}^{(t-1)}+(1−γ)dₘₓ; (iii) quantizes x to nₓ(odd) bins in −μₓ, . . . , μₓ by taking

$${\hat{x}}_{i} = round ( \frac{clip ( {x}_{i} {μ}_{x} )}{{x}_{width}} )$$

with x_{width}=2μₓ/nₓ, where clip (x, b) clips x in the range −b, . . . , b; (iv) quantizes d to n_{d}(odd) bins in −μ_{d}, . . . , μ_{d} by taking

$${\hat{d}}_{i} = round ( \frac{clip ( {x}_{i} {μ}_{d} )}{{x}_{width}} )$$

with d_{width}=2μ_{d}/n_{d}; and (v) stores the discretized \hat{d} and \hat{x} for slower background computation, as will be discussed below.

Processing proceeds to operation S415, where the training process waits for asynchronous computation of the previous cycle to complete. More specifically, in this operation, the training process makes sure that the asynchronous background computation of the rank-update (onto Xₜ₋₁, as will be discussed below with respect to operation S425) of the last/previous update cycle has finished—if not, the update process waits for the background computation to complete.

Processing proceeds to operation S418, where the training process subtracts pᵢθ from the k-th row of Xₜ₋₁. In some cases, a momentum is added, such that only a fraction (e.g., 0.5) of pᵢθ is subtracted from the k-th row of Xₜ₋₁.

Processing proceeds to operation S420, where the training process advances k (i.e., the current row/column index) by one (with wrap around) and copies the k-th row (or column) of the matrix Xₜ₋₁ into vector \hat{z}, which will be utilized in subsequent operations.

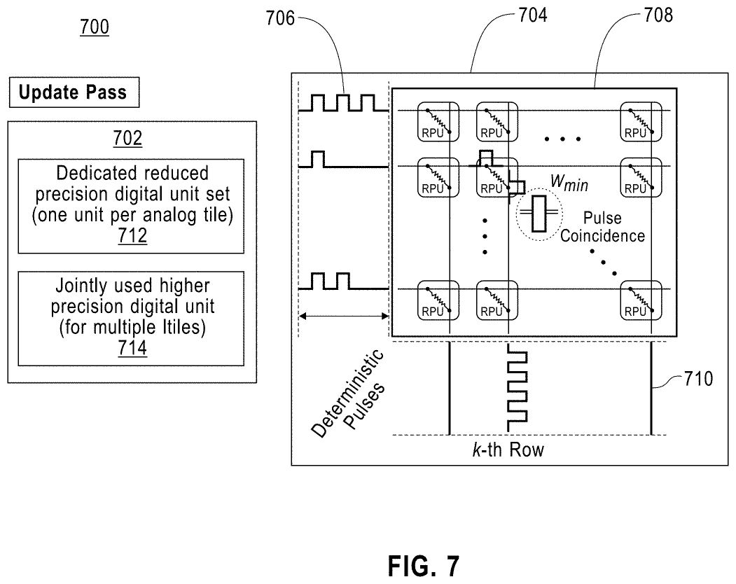

Processing proceeds to operation S425, where the training process, on an asynchronous, dedicated digital compute unit, starts the O(nonzero(\hat{d})nonzero(\hat{x})) computation of the rank update (outer product) using the saved \hat{d} and \hat{x}, by computing Xₜ=Xₜ₋₁+\hat{x}\hat{d}^{T} using sparse integer arithmetic. As an example, the dedicated digital compute unit may be a reduced precision digital processing unit of dedicated reduced precision digital unit set 712, described below with respect to FIG. 7.

It should be noted that in this embodiment, X is the same size as W, but is stored in integer format having

$$⌈ {log}_{2} ( \frac{m ( {n}_{d} - 1 )}{2} + 1 ) ⌉$$

(including sign), where m is a small integer (e.g., m=8). It should also be noted that if n_{d} is small (e.g., 3), \hat{d}ₗ can only be −1, 0, or 1, and multiplication reduces to selecting non-zero rows and applying signs and integer additions.

Processing proceeds to operation S430, where the training process, without waiting for S425 to complete, computes

$$θ = \frac{∈}{λ {d}_{width} {x}_{width}} ,$$

where ϵ is the device granularity (Δwₘᵢₙ) and λ is the learning rate.

Processing proceeds to operation S435, where the training process computes, for the k-th row: pᵢ=└\hat{z}ₗ/θ┘.

Processing proceeds to operation S440, where the training process performs the update step of SGD, using pᵢ as the inputs and the (negative) k-th one hot vector as the “error”, to perform a rank-1 update onto the crossbar W, so that pᵢ is the number of pulses fired for input i. As an example, the inputs may correspond to input pulses 706 and the error may correspond to output pulses 710, discussed below with respect to FIG. 7.

Processing proceeds to operation S445, where the training process advances t by one. Upon completion of operation S445, processing continues, where applicable, back at operation S405 for the next mini-batch cycle.

FIG. 5 is diagram depicting analog RPU array system 500, in a forward pass, according to an embodiment of the present invention. In the embodiment depicted in FIG. 5, each of digital inputs 502 represents a separate digital input x to analog RPU array system 500. In the forward pass, digital inputs 502 are converted by digital to analog (DA) converter 504 into respective analog input pulses 506, which are applied to the respective rows of RPU array 508. The analog outputs 510 of RPU array 508 are then converted by analog to digital (AD) converter 512 into digital outputs 514, where each of digital outputs 514 represents a separate digital output y.

FIG. 6 is a diagram depicting transposed analog RPU array system 600, in a backward pass, according to an embodiment of the present invention. In the embodiment depicted in FIG. 6, processing is generally the same as the forward pass described above with respect to FIG. 5, except that a transposed analog RPU array (RPU array 608) is utilized for the backward pass. In the transposed analog RPU array, the inputs and the outputs of the array are exchanged, such that the former output becomes the input and the former input becomes the output. In the backward pass, digital inputs 602 are converted by digital to analog (DA) converter 604 into respective analog input pulses 606, which are applied to the respective rows of RPU array 608. The analog outputs 610 of RPU array 608 are then converted by analog to digital (AD) converter 612 into digital outputs 614, where each of digital outputs 614 represents a separate digital output y.

FIG. 7 is a diagram depicting digital and analog RPU array system 700, in an update pass, according to an embodiment of the present invention. In the embodiment depicted in FIG. 7, processing takes place in both digital portion 702 and analog portion 704. Digital portion 702 includes dedicated reduced precision digital unit set 712, which includes one reduced precision digital processing unit per analog tile of RPU array 708, and jointly used higher precision digital unit 714, which is used for multiple tiles of RPU array 708. In this embodiment, the reduced precision digital unit set 712 is used to store the reduced precision vectors \hat{x} and \hat{d} that are needed for the update pass only, where the higher precision digital unit 714, is used to pass values to the next layer's input in the case of the forward pass and the backward pass. It should also be noted that, in this embodiment, x and d need not be stored in high precision, as x and d are immediately consumed by the next layer. However, \hat{d} at least needs to be stored (or kept in memory) in low precision due to the asynchronous compute of the rank-update.

Referring still to FIG. 7, Analog portion 704 includes input pulses 706, RPU array 708, and output pulses 710. As depicted in FIG. 7, during the update pass, certain operations—such as those discussed above with respect to FIG. 4—are performed by digital portion 702, with the results transferred to RPU array 708 of analog portion 704 via deterministic pulses (input pulses 706 and output pulses 710). Also as depicted in FIG. 7, the update results from digital portion 702 are transferred to RPU array 708 one row/column at a time (i.e., the “k-th” row), as described above with respect to FIG. 4.

FIG. 8 is a diagram depicting example runtime scheme 800, according to an embodiment of the present invention. In this embodiment, each layer of the DNN has a corresponding analog RPU array—distributed across one or more communicatively connected computers and/or environments—and each rectangular box represents a forward, backward, or update pass being performed for one of those layers. In runtime scheme 800, a mini-batch of training examples is processed by each analog RPU array and corresponding digital update component, beginning with the forward pass (“F”) for each layer/RPU array and continuing with the backward pass (“B”) for each layer/RPU array. Once the backward pass completes for given layer, the update pass begins by: (i) applying the results of the update pass from the previous cycle (X(t−1)) to W (the weight values in the crossbar in analog), and (ii) beginning the asynchronous calculation of the outer product of the outputs of the forward pass and the backward pass for the layer in the current cycle (X(t)). The process of calculating the outer product for a layer while simultaneously performing the backward pass or forward pass for another layer is sometimes referred to as calculating the outer product in the “bubble.” Once processing returns back to the layer for a subsequent cycle (X(t+1)), (X(t))—which has finished calculating—is applied to W.

Various embodiments of the present invention improve upon existing mixed precision configurations in one or more of the following ways: (i) providing the number format of x and d in low precision integer, instead of in a combination of floating point and low precision integer; (ii) avoiding the need to scale ΔW_{q}, thus significantly reducing the compute, where existing configurations typically require scaling by calculating O(nonzero(\hat{d})nonzero(\hat{x})) in high precision; (iii) providing the number format of X in low precision integer (e.g., 8 bit) instead of high precision, significantly reducing on-chip memory requirements; (iv) performing addition onto X in low precision instead of high precision, thereby reducing runtime; (v) transferring X to W at most one row per sample (all rows for a large mini-batch), instead of transferring multiple rows each sample; (vi) providing for a dynamic, instead of fixed, threshold θ computation, with current learning rate and current bin-widths; (vii) asynchronously, instead of synchronously, applying the rank update of X, hidden behind analog forward/backward/update if a dedicated processor per tile is available; (viii) implementing an X matrix in integer precision, which requires a dynamic quantization of error and activation, but which greatly improves the noise robustness of the update and thus the attainable DNN accuracy, and which significantly reduces storage requirements; (ix) providing a dynamic, momentum-based quantization scheme for input and error activations in the DNN training process to allow for 8-bit integer update accumulation (plus additional bits to accommodate for batch size); and/or (x) reducing noise over existing configurations that perform rank-update calculations directly in analog without any intermediate storage of d or a digital matrix X.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
receiving, by one or more computer processors, outputs pertaining to a first step of a training process being performed on an analog resistive processing unit (RPU) array, the analog RPU array corresponding to a layer of a deep neural network (DNN), the outputs including: (i) a first output of a first step forward pass of a previous layer, and (ii) a second output of a first step backward pass of a next layer;
converting, by one or more computer processors, the first output and the second output into a format having less precision than a format of the first output and a format of the second output, yielding a converted first output and a converted second output;
initiating, by one or more computer processors, a calculation of an update parameter for a first step update pass of the layer, the calculation utilizing the converted first output and the converted second output;
receiving, by one or more computer processors, outputs pertaining to a second step of the training process being performed on the analog RPU array; and
based, at least in part, on the receiving of the outputs pertaining to the second step of the training process being performed on the analog RPU array, applying, by one or more computer processors, the update parameter for the first step update pass of the layer to the analog RPU array.

2. The computer-implemented method of claim 1, wherein the training process utilizes stochastic gradient descent.

3. The computer-implemented method of claim 1, further comprising, subsequent to receiving the outputs pertaining to the first step of the training process being performed on the analog RPU array, and prior to receiving the outputs pertaining to the second step of the training process being performed on the analog RPU array:
receiving, by one or more computer processors, outputs pertaining to the first step of the training process being performed on a next analog RPU array, the next analog RPU array corresponding to the next layer; and
receiving, by one or more computer processors, outputs pertaining to the second step of the training process being performed on the next analog RPU array.

4. The computer-implemented method of claim 1, wherein the converted first output and the converted second output are vectors of integers.

5. The computer-implemented method of claim 4, wherein integers in the vectors of integers are eight bits or less.

6. The computer-implemented method of claim 1, wherein the applying of the update parameter for the first step update pass to the analog RPU array utilizes a learning rate and bin-widths associated with the outputs pertaining to the second step of the training process being performed on the analog RPU array.

7. The computer-implemented method of claim 1, wherein the initiating of the calculation of the update parameter for the first step update pass of the layer includes sending the converted first output and the converted second output to a set of digital processing units, the set of digital processing units having, for each analog tile of the analog RPU array, a corresponding digital processing unit.

8. A computer program product comprising one or more computer readable storage media and program instructions collectively stored on the one or more computer readable storage media, the program instructions executable by one or more computer processors to cause the one or more computer processors to perform a method comprising:
receiving outputs pertaining to a first step of a training process being performed on an analog resistive processing unit (RPU) array, the analog RPU array corresponding to a layer of a deep neural network (DNN), the outputs including: (i) a first output of a first step forward pass of a previous layer, and (ii) a second output of a first step backward pass of a next layer;
converting the first output and the second output into a format having less precision than a format of the first output and a format of the second output, yielding a converted first output and a converted second output;
initiating a calculation of an update parameter for a first step update pass of the layer, the calculation utilizing the converted first output and the converted second output;
receiving outputs pertaining to a second step of the training process being performed on the analog RPU array; and
based, at least in part, on the receiving of the outputs pertaining to the second step of the training process being performed on the analog RPU array, applying the update parameter for the first step update pass of the layer to the analog RPU array.

9. The computer program product of claim 8, wherein the training process utilizes stochastic gradient descent.

10. The computer program product of claim 8, the method further comprising, subsequent to receiving the outputs pertaining to the first step of the training process being performed on the analog RPU array, and prior to receiving the outputs pertaining to the second step of the training process being performed on the analog RPU array:
receiving outputs pertaining to the first step of the training process being performed on a next analog RPU array, the next analog RPU array corresponding to the next layer; and
receiving outputs pertaining to the second step of the training process being performed on the next analog RPU array.

11. The computer program product of claim 8, wherein the converted first output and the converted second output are vectors of integers.

12. The computer program product of claim 11, wherein integers in the vectors of integers are eight bits or less.

13. The computer program product of claim 8, wherein the applying of the update parameter for the first step update pass to the analog RPU array utilizes a learning rate and bin-widths associated with the outputs pertaining to the second step of the training process being performed on the analog RPU array.

14. The computer program product of claim 8, wherein the initiating of the calculation of the update parameter for the first step update pass of the layer includes sending the converted first output and the converted second output to a set of digital processing units, the set of digital processing units having, for each analog tile of the analog RPU array, a corresponding digital processing unit.

15. A computer system comprising:
one or more analog resistive processing unit (RPU) arrays;
one or more computer processors; and
one or more computer readable storage media;
wherein:
the one or more computer processors are structured, located, connected and/or programmed to execute program instructions collectively stored on the one or more computer readable storage media; and
the program instructions, when executed by the one or more computer processors, cause the one or more computer processors to perform a method comprising:
receiving outputs pertaining to a first step of a training process being performed on an analog RPU array of the one or more analog RPU arrays, the analog RPU array corresponding to a layer of a deep neural network (DNN), the outputs including: (i) a first output of a first step forward pass of a previous layer, and (ii) a second output of a first step backward pass of a next layer;
converting the first output and the second output into a format having less precision than a format of the first output and a format of the second output, yielding a converted first output and a converted second output;
initiating a calculation of an update parameter for a first step update pass of the layer, the calculation utilizing the converted first output and the converted second output;
receiving outputs pertaining to a second step of the training process being performed on the analog RPU array; and
based, at least in part, on the receiving of the outputs pertaining to the second step of the training process being performed on the analog RPU array, applying the update parameter for the first step update pass of the layer to the analog RPU array.

16. The computer system of claim 15, wherein the training process utilizes stochastic gradient descent.

17. The computer system of claim 15, the method further comprising, subsequent to receiving the outputs pertaining to the first step of the training process being performed on the analog RPU array, and prior to receiving the outputs pertaining to the second step of the training process being performed on the analog RPU array:
receiving outputs pertaining to the first step of the training process being performed on a next analog RPU array of the one or more analog RPU arrays, the next analog RPU array corresponding to the next layer; and
receiving outputs pertaining to the second step of the training process being performed on the next analog RPU array.

18. The computer system of claim 15, wherein the converted first output and the converted second output are vectors of integers.

19. The computer system of claim 18, wherein integers in the vectors of integers are eight bits or less.

20. The computer system of claim 15, wherein:
the one or more computer processors include a plurality of computer processors;
the plurality of computer processors includes a subset of dedicated computer processors having corresponding computer processors for each analog tile of the analog RPU array; and
the initiating of the calculation of the update parameter for the first step update pass of the layer includes sending the converted first output and the converted second output to the subset of dedicated computer processors.
